(19) United States
(12) Patent Application Publication
(10) Pub. No.: US 2011/0081587 A1
(43) Pub. Date: Apr. 7, 2011

(54) Apparatus for Detecting Leak in Fuel Cells

(75) Inventors: Gu-Gon Park, Daejeon (KR); Minjin Kim, Daejeon (KR); Young-Jun Sohn, Daejeon (KR); Young-Woo Choi, Cheongju-si (KR); Seok-Hee Park, Daejeon (KR); Sung-Dae Yim, Daejeon (KR); Tae-Hyun Yang, Daejeon (KR); Young-Gi Yoon, Daejeon (KR); Won-Yong Lee, Daejeon (KR); Chang-Soo Kim, Incheon (KR)

(73) Assignee: KOREA INSTITUTE OF ENERGY RESEARCH, Daejeon (KR)

(21) Appl. No.: 12/870,421

(22) Filed: Aug. 27, 2010

(30) Foreign Application Priority Data
Oct. 6, 2009 (KR) 10-2009-0094514

(51) Int. Cl. H01M 8/04

(52) U.S. Cl. 429/428

(57) ABSTRACT

Provided is an apparatus for detecting leak in fuel cells. The apparatus includes: a detection gas intake unit connected to a detection gas storage; a supply unit supplying detection gas to supply manifolds of the fuel cells; a recovering unit connected to exhaust manifolds of the fuel cells; and a measuring unit measuring pressure of the detection gas supplied to the fuel cells, wherein in the fuel cells, a product and cooling fluid are exhausted through the exhaust manifolds after cathode/anode reaction gas and cooling fluid are supplied to the inside through the supply manifolds to generate an electrochemical reaction. Accordingly, presence of leak and leaked portions of the entire fuel cells are detected by using an inert detection gas.

### CROSS-REFERENCE TO RELATED APPLICATIONS

This application claims priority under 35 U.S.C. §119 to Korean Patent Application No. 10-2009-0094514, filed on Oct. 6, 2009, in the Korean Intellectual Property Office, the disclosure of which is incorporated herein by reference in its entirety.

### TECHNICAL FIELD

The following disclosure relates to an apparatus for detecting leak in fuel cells, and in particular, to a leak detecting apparatus in the fuel cells, in which a product and cooling fluid are exhausted through exhaust manifolds after cathode/anode reaction gas and cooling fluid are supplied to an inside through the supply manifolds to generate an electrochemical reaction. More particularly, the apparatus for detecting leak in fuel cells, includes a detection gas intake unit, a supply unit, a recovering unit and a measuring unit. The detection gas intake unit is connected to a detection gas storage, the supply unit supplies detection gas to supply manifolds of the fuel cells, the recovering unit is connected to exhaust manifolds of the fuel cells and the measuring unit measures pressure of the detection gas supplied to the fuel cells. The apparatus for detecting leak in fuel cells may detect presence of leak and leak portions in the entire fuel cells by using an inert detection gas.

### BACKGROUND

A fuel cell is a device that generates electricity through electrochemical reaction between hydrogen and oxygen. With such advantages as high efficiency, high current density and output density, short startup time and fast response to load change as compared to other generators, it is widely applicable as power source of zero-emissions vehicles, residential power generation, and mobile or military applications.

According to types of used electrolytes, the fuel cell is divided into a polymer electrolyte membrane fuel cell (PEMFC), a phosphoric acid fuel cell (PAFC), a molten carbonate fuel cell (MCFC) and a solid oxide fuel cell (SOFC). Since the PEMFC is operable within a temperature range of room temperature, which is low operation temperature, to 200° C. and has a very high power density, the PEMFC may be applied as diverse power sources such as automobiles, home appliances and portable devices.

The fuel cells including PEMFC basically form a stack where a plurality of unit cells are layered and include a cooling unit between the unit cells.

A configuration of the unit cell of PEMFC will be described in detail. The fuel cell has a membrane electrode assembly (MBA) as a main constituent element in its innermost location. The membrane electrode assembly includes an electrolyte membrane capable of conducting protons, and a catalyst layer applied on both sides of the electrolyte membrane to allow reaction of oxygen and hydrogen, i.e. a cathode and an anode. Gas diffusion layers (GDLs) are located at an outer portion of the membrane electrode assembly, i.e. at an outside of the cathode and the anode. Also, separators equipped with reaction gas flow fields to allow supply of fuel and discharge of water produced by the reaction are provided outside the gas diffusion layers.

At the anode of the fuel cell, hydrogen is oxidized and, as a result, a proton and an electron are produced. The proton and the electron travel to the cathode through the electrolyte membrane and a wire, respectively. Simultaneously, at the cathode, oxygen is reduced by accepting the proton and the electron from the anode to produce water. Electrical energy is generated by the electron traveling through the wire and the proton traveling through the electrolyte membrane. Since voltage obtained through the single cell, i.e., the unit cell, has a low value of 1V or less, a desired output is acquired by forming a stack configured by layering a plurality of unit cells.

In the stack, the reaction gas, i.e., the fuel, air and cooling fluid are supplied to each of the unit cell and the cooling unit through a manifold. The manifold may be formed outside the stack or inside the stack by forming a vacant channel inside the stack. Maintaining an airtight condition to supply the reaction gas and the cooling fluid to the anode and the cathode of each unit cell without leak to the outside of the stack and without mixing of the reaction gas and the cooling fluid is very important in view of securing basic performance and durability of the stack. Accordingly, a leak test is performed before supply as a product.

JP Patent Laid-open No. 2004-515889 (Cited Invention 1) discloses a method for determining whether there is leak when voltage is lowered, by monitoring progresses of the voltage of the fuel cells according to a time after sending a test gas (hydrogen containing gas of 0.1 to 20% and oxygen containing gas of 0.1-30%) to each manifold in a no-load state.

However, the above method requires a device for measuring voltage and has an ignition risk when the test gas is leak to the outside. There is also a risk that cell may be damaged by generation of electrochemical reaction of supplied hydrogen and oxygen on an electrode catalyst when there is serious damage in the MEA. In addition, the Cited Invention 1 detects whether airtight between unit cells in a membrane is well maintained but cannot exactly grasp the location of the cause that the leak is generated. That is, the Cited Invention 1 cannot additionally determine whether the location of the cause is a cathode, an anode or a cooling unit to be formed between the membranes. The Cited Invention 1 does not suggest an improvement direction of the detailed product since it cannot detect leak to the outside in the entire fuel cell stack except leak between unit cells.

### SUMMARY

An embodiment of the present invention is directed to providing an apparatus for detecting leak in fuel cells that safely and precisely detect final leak of the fuel cells by using an inert detection gas.

Another embodiment of the present invention is directed to providing a method that checks leak without an actual operation process on the fuel cells and prevents physical modification and damage on the fuel cell stack.

Still another embodiment of the present invention is directed to providing an apparatus for detecting leak that detects detailed locations of the leak and suggests improvement direction by providing a configuration of individually injecting and comparing detection gas into each flow field of fuel cells reaction gas and cooling fluid.

Still another embodiment of the present invention is directed to providing an apparatus for detecting leak that quickly and visually detects leak by additionally connecting a bubble generator capable of checking leak of detection gas.

In one general aspect, an apparatus for detection leak in fuel cells, includes: a detection gas intake unit connected to a detection gas storage; a supply unit supplying detection gas to supply manifolds of the fuel cells; a recovering unit connected to exhaust manifolds of the fuel cells; and a measuring unit measuring pressure of the detection gas supplied to the fuel cells, wherein in the fuel cells that a product and cooling fluid are exhausted through the exhaust manifolds after cathode/anode reaction gas and cooling fluid are supplied to the inside through the supply manifolds to generate an electrochemical reaction.

Each of the supply unit and the recovering unit may include 1st, 2nd and 3rd supply parts and 1st, 2nd and 3rd recovering parts, which are respectively connected to supply/exhaust manifolds of anode reaction gas, cathode reaction gas and cooling fluid.

End portions of the 1st, 2nd and 3rd recovering parts may be connected to a flowmeter or a detection gas bubble generator.

The apparatus further includes: a forward pressure regulator for regulating supply pressure of the detection gas to the supply unit.

The apparatus further includes: a vent unit for exhausting detection gas remaining in the fuel cells and the leak detecting apparatus; and a relief valve for controlling exhaust pressure of the detection gas in the vent unit.

The detection gas may be an inert gas such as nitrogen or air.

Other features and aspects will be apparent from the following detailed description, the drawings, and the claims.

### BRIEF DESCRIPTION OF THE DRAWINGS

FIG. 1 shows a conventional leak detecting apparatus.

FIG. 2 is a perspective view showing a leak detecting apparatus according to an exemplary embodiment.

FIG. 3 is a top view showing the leak detecting apparatus of FIG. 2.

FIG. 4 is a front view showing the leak detecting apparatus of FIG. 2.

FIG. 5 is a rear view showing the leak detecting apparatus of FIG. 2.

FIG. 6 is a flowchart describing the leak detecting apparatus according to an exemplary embodiment.

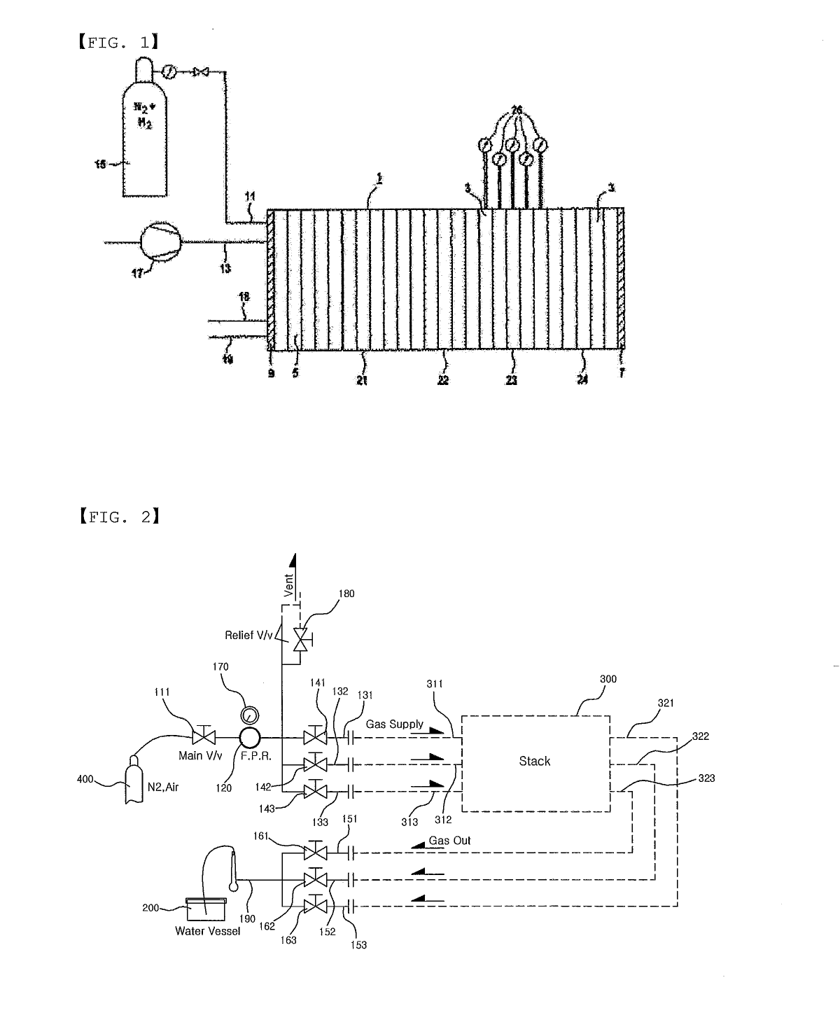

### DETAILED DESCRIPTION OF MAIN ELEMENTS

100: leak detecting apparatus
110: intake unit 111: intake valve
120: forward pressure regulator 130: supply unit
131, 132, 133: 1st, 2nd and 3rd supply parts
141, 142, 143: 1st, 2nd and 3rd supply valves
150: recovering unit 151, 152, 153: 1st, 2nd and 3rd recovering parts
161, 162, 163: 1st, 2nd and 3rd recovering valve
170: measuring unit 180: vent unit
181: vent valve 182: relief valve
190: bubble connecting unit
200: bubble generator 300: fuel cells
310: supply manifold 311: anode reaction gas supply manifold
312: cooling fluid supply manifold
313: cathode reaction gas supply manifold
320: exhaust manifold 321: anode reaction gas exhaust manifold
322: cooling fluid exhaust manifold
323: cathode reaction gas exhaust manifold
400: detection gas storage

### DETAILED DESCRIPTION OF EMBODIMENTS

Hereinafter, a leak detecting apparatus 100 in fuel cells according to exemplary embodiments will be described in detail with reference to the accompanying drawings.

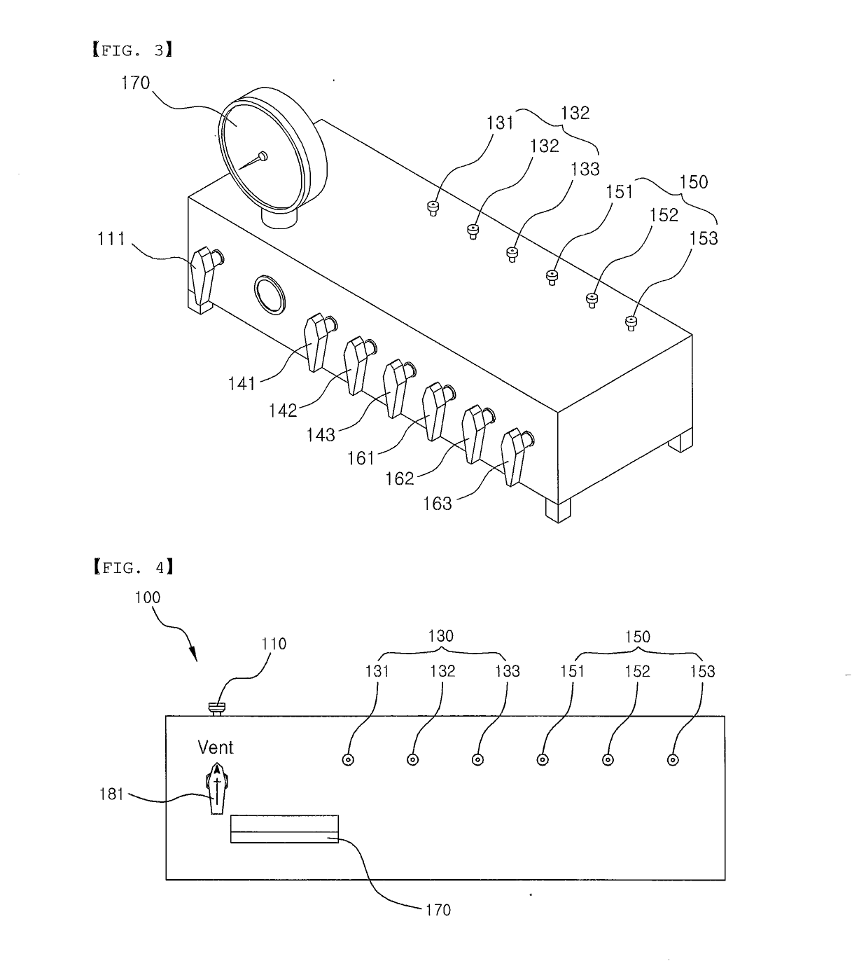

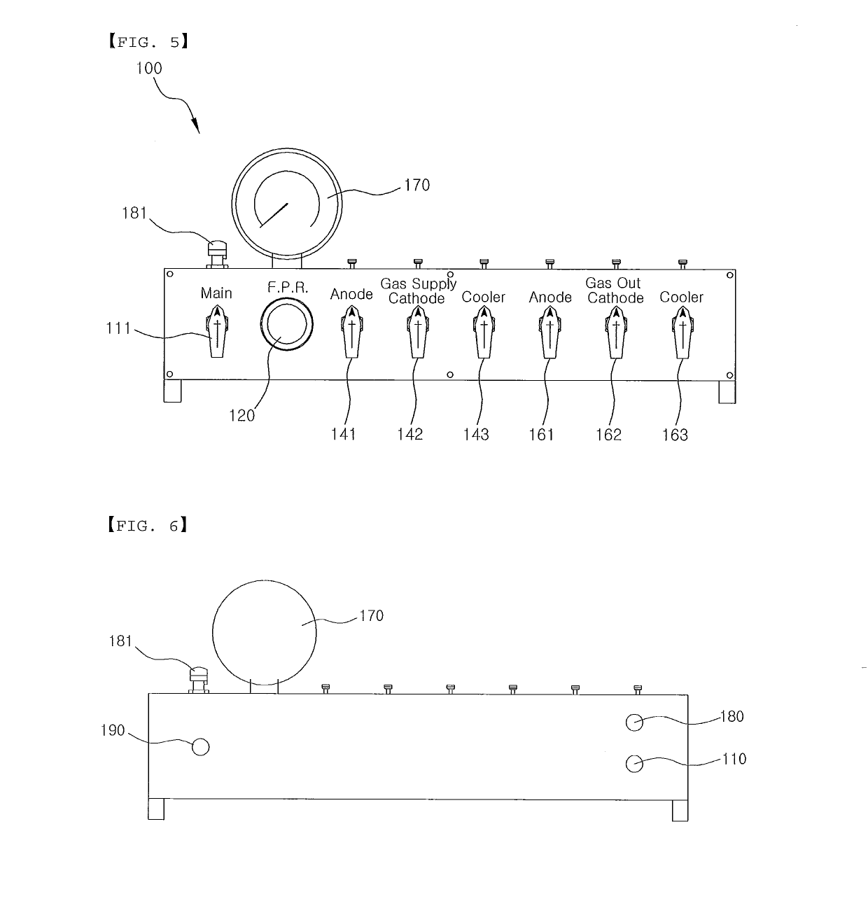

FIGS. 2 to 5 are a perspective view, a top view, a front view, and a rear view of the leak detecting apparatus 100 in the fuel cells of the present invention. FIG. 6 is a flowchart describing the leak detecting apparatus 100 according to an exemplary embodiment of the present invention.

The leak detecting apparatus 100 includes a detection gas intake unit 110 connected to a detection gas storage 400; a supply unit 130 supplying detection gas to supply manifolds 311, 312 and 313 of the fuel cells; a recovering unit 150 connected to exhaust manifolds 321, 322 and 323 of the fuel cells; a measuring unit 170 measuring pressure of the detection gas supplied to the fuel cells 300; and a vent unit 180 exhausting detection gas remaining in the fuel cells 300 and the leak detecting apparatus 100 to the outside.

The intake unit 110 included in a rear portion of the leak detecting apparatus 100 supplies detection gas from the detection gas storage 400 to the leak detecting apparatus 100 by opening/closing of an intake valve 111 of a front portion. It is preferred to minimize ignition risk by using an inert gas such as nitrogen or air as the detection gas.

The supply unit 130 supplies detection gas of regular pressure to the supply manifolds 311, 312 and 313 of the fuel cells via a forward pressure regulator 120 and is opened/closed by supply valves 141, 142 and 143. The supply unit 130 is not configured to be a single body. Preferably, the supply unit 130 includes 1st, 2nd and 3rd supply parts 131, 132 and 133 and the supply valves 141, 142 and 143, which are respectively connected to the supply manifolds 311, 312 and 313 of anode reaction gas, cooling fluid and cathode reaction gas in order to make it possible to detect leak of each flow field to be described hereafter.

The recovering unit 150 recovers detection gas, which is supplied through the supply manifolds 311, 312 and 313, flows in the inside of the fuel cells 300, and is exhausted through the exhaust manifolds 321, 322 and 323. The other end of the recovering unit 150 is opened/closed by recovering valves 161, 162 and 163. Preferably, the recovering unit 150 includes 1st, 2nd and 3rd recovering parts 151, 152 and 153 and the recovering valves 161, 162 and 163, which are respectively connected to the exhaust manifolds 321, 322 and 323 of cathode reaction gas, cooling fluid and anode reaction gas in the same manner as the supply unit 130.

The measuring unit 170 is located in a predetermined location between the supply valves 141, 142 and 143 and the recovering valves 161, 162 and 163 and senses pressure change of the detection gas supplied at regular pressure.

The vent unit 180 exhausts the detection gas remaining in the fuel cells 300 and the leak detecting apparatus 100 to the outside. The vent unit 180 may be located in any place but is set to be located in a front end of the supply unit 130 to completely exhaust the detection gas from the supply unit. In particular, the vent unit 180 includes a relief valve controlling exhaust pressure of the detection gas to prevent a risk that a membrane electrode assembly (MEA) may be damaged due to rapid increase of the exhaust pressure.

Also, the vent unit 180 and a vent valve 181 for exhausting detection gas remaining in the middle of detection or after detection are included.

The vent unit 180 includes an additional relief valve to prevent that the MEA as a cell component is physically damaged when excessive pressure is applied to a fuel cell stack by unexpected accident such as breakdown of the forward pressure regulator 120.

The forward pressure regulator (FPR) 120 is additionally included to regulate the supply pressure of the detection gas to the supply unit 130. The forward pressure regulator 120 may minimize fluid change due to controlling of open/close of diverse valves.

The leak detecting apparatus 100 includes constituents elements connected to the outside such as the fuel cells 300 or the detection gas storage 400 on a top surface or a rear surface of the leak detecting apparatus 100 and includes diverse gauges and valves on a front surface to make manual operation easy.

End portions of the 1st, 2nd and 3rd recovering parts 151, 152 and 153 are in fluid communication with a bubble generator 200 of the detection gas such as a water tank through a bubble connecting unit 190 or a flowmeter (not shown) at a rear surface of the leak detecting apparatus 100 in FIG. 4. Accordingly, it is possible to quickly check if the detection gas flows into each recovering unit 150, by confirming the flow of the flowmeter and generation of bubbles in the bubble generator 200 with the naked eyes besides sensing the change of pressure.

A method for detecting leak by using the leak detecting apparatus 100 of the present invention will be described with reference to FIG. 6 hereinafter.

The leak detecting method is divided into two processes. First, the entire fuel cells 300 are detected in order if there is any leak to the outside.

The supply manifold 311 of the anode reaction gas of the fuel cells 300 is connected to the 1st supply part 131 of the leak detecting apparatus and the exhaust manifold 321 is connected to the 2nd recovering part 151. In the same manner, the cooling fluid supply/exhaust manifolds 312 and 322 are connected to the 2nd supply unit/recovering part 132 and 152. The cathode reaction gas supply/exhaust manifolds 313 and 323 are connected to the 3rd supply part/recovering part 133 and 153. After the pressure of the forward pressure regulator 120 is set at a desired level, the detection gas is supplied from the detection gas storage 400 by opening the intake valve 111 of the front surface and the pressure is regulated to the regular level by the forward pressure regulator 120.

The recovering valves 161, 162 and 163 are closed after sequentially filling the supply valves 141, 142 and 143, the fuel cells 300 and then the recovering valves 161, 162 and 163 with the detection gas by opening the 1st, 2nd and 3rd supply valves 141, 142 and 143 and the recovering valves 161, 162 and 163.

It is detected whether there is any leak to the outside in the entire fuel cells 300 by checking if the pressure drops after a predetermined time in comparison with the pressure of the measuring unit 170 right before closing the valve.

After it is confirmed that there is no leak to the outside, it is checked whether there is leak between the flow fields inside the fuel cells 300. That is, it is detected whether airtight between layered unit cells is well maintained and airtight between an anode and a cathode is well maintained through the membrane electrode assembly inside the unit cell. An opening/closing order of the valve for detection is as follows.

TABLE 1
<valve position>

| | 1st | 2nd | 3rd | 1st | 2nd | 3rd |
|---|---|---|---|---|---|---|
| | supply | supply | supply | recovery | recovery | recovery |
| Anode | opening | closing | closing | closing | opening | opening |
| reaction | | | | | | |
| gas | | | | | | |
| Cathode | closing | opening | closing | opening | closing | opening |
| reaction | | | | | | |
| gas | | | | | | |
| Cooling | closing | closing | opening | opening | opening | closing |
| fluid | | | | | | |

In order to detect whether the anode reaction gas is supplied/exhausted without leak, as shown in Table 1, the supply valve opens only the 1st supply valve 141 connected to the supply manifold of the anode reaction gas and the detection gas is supplied to the 1st supply part 131 at a regular pressure. The rest supply valves 142 and 143 are closed. The recovering unit closes the 1st recovering valve 161 connected to the exhaust manifold 321 of the anode reaction gas and opens the rest recovering valves 162 and 163. A specific leak location of the anode reaction gas is obtained by sequentially opening the 2nd recovering valve 162 and the 3rd recovering valve 163.

That is, when there is no leak inside the fuel cells 300 on the flow field where the anode reaction gas flows, the pressure is maintained within a predetermined range and the detection gas recovered to the 2nd recovering part 152 and the 3rd recovering part 153 is not detect. However, when the anode reaction gas is leaked to the cooling unit, the detection gas is detected by the 2nd recovering part 152 in opening of the 2nd recovering valve 162. When the airtight with membrane electrode assembly is not maintained, the detection gas is detected by the 3rd recovering part 153 in opening of the 2nd recovering valve 163. Determining whether the detection gas is detected may be performed by a pressure gauge or flowmeter of the measuring unit 170, or visually by the bubble generator 200 of the detection gas.

In the same method, when the reaction gas is supplied by opening only the supply units 133 and 132 connected to the supply manifolds 313 and 312 of the cathode reaction gas or the cooling fluid to be detected, it is checked whether there is leak by closing the recovering units 153 and 152 and opening other recovering units.

Detection using the leak detecting apparatus 100 of the present invention is described according to the example that the detection is performed by the operation of manually opening/closing the valve. However, fast automatic detection may be also performed by a control unit for detecting in order whether there is leak by automatically controlling opening/closing of the valve.

The leak detecting apparatus in the fuel cells of the present invention may safely detect leak of the fuel cells by using the inert gas. Since leak may be checked without an actual operation process on the fuel cells, it is possible to detect leak without physical modification or damage of the fuel cell stack. Also, since leak is detected by sensing the pressure change, precise detection is possible and effect by the pressure change according to the valve operation may be minimized through the pressure regulator.

In addition, leak is quickly and visually sensed through the flowmeter or the bubble generator of the detection gas. The leak between the flow fields as well as the leak to the outside in the entire fuel cells may be detected through respective connection to the supply/exhaust manifold of the reaction gas and the cooling fluid may be detected. Furthermore, quick detection may be automatically performed by programming the detection order.

It will be apparent that the invention is not limited to the embodiments and application fields are diverse, and various changes and modifications may be made by those skilled in the art without deviating from the basic concept and scope of the invention as set forth in the appended claims.

What is claimed is:

1. An apparatus for detecting leak in fuel cells, comprising:
a detection gas intake unit connected to a detection gas storage;
a supply unit supplying detection gas to supply manifolds of the fuel cells;
a recovering unit connected to exhaust manifolds of the fuel cells; and
a measuring unit measuring pressure of the detection gas supplied to the fuel cells,
wherein in the fuel cells, a product and cooling fluid are exhausted through the exhaust manifolds after cathode/anode reaction gas and cooling fluid are supplied to the inside through the supply manifolds to generate an electrochemical reaction.

2. The apparatus of claim 1, wherein each of the supply unit and the recovering unit includes 1st, 2nd and 3rd supply parts and 1st, 2nd and 3rd recovering parts, which are respectively connected to supply/exhaust manifolds of anode reaction gas, cooling fluid and cathode reaction gas.

3. The apparatus of claim 2, wherein end portions of the 1st, 2nd and 3rd recovering parts are connected to a flowmeter or a detection gas bubble generator.

4. The apparatus of claims 1, further comprising:
a forward pressure regulator regulating supply pressure of the detection gas to the supply unit.

5. The apparatus of claim 4, further comprising:
a vent unit exhausting detection gas remaining in the fuel cells and the leak detecting apparatus to the outside; and
a relief valve controlling exhaust pressure of the detection gas in the vent unit.

6. The apparatus of claim 4, wherein the detection gas is an inert gas such as nitrogen or air.

7. The apparatus of claims 2, further comprising:
a forward pressure regulator regulating supply pressure of the detection gas to the supply unit.

8. The apparatus of claim 7, further comprising:
a vent unit exhausting detection gas remaining in the fuel cells and the leak detecting apparatus to the outside; and
a relief valve controlling exhaust pressure of the detection gas in the vent unit.

9. The apparatus of claim 7, wherein the detection gas is an inert gas such as nitrogen or air.

10. The apparatus of claims 3, further comprising:
a forward pressure regulator regulating supply pressure of the detection gas to the supply unit.

11. The apparatus of claim 10, further comprising:
a vent unit exhausting detection gas remaining in the fuel cells and the leak detecting apparatus to the outside; and
a relief valve controlling exhaust pressure of the detection gas in the vent unit.

12. The apparatus of claim 10, wherein the detection gas is an inert gas such as nitrogen or air.
